(19) United States
(12) Patent Application Publication
(10) Pub. No.: US 2021/0055023 A1
(43) Pub. Date: Feb. 25, 2021

(54) VAPOR CYCLE MACHINE AVAILABILITY FOR HIGH IMPACT APPLICATIONS

(71) Applicant: The Boeing Company, Chicago, IL (US)

(72) Inventors: Michael L. Trent, Everett, WA (US); Zachary G. Brown, Everett, WA (US); Chetan B. Megchiani, Bothell, WA (US)

(21) Appl. No.: 16/547,258

(22) Filed: Aug. 21, 2019

(51) Int. Cl. F25B 43/00; F25B 49/02

(52) U.S. Cl. CPC F25B 43/003; F25B 2600/2501; F25B 49/02

(57) ABSTRACT

A filter dryer functions bypass system in a vapor cycle machine includes a refrigerant filter/dryer receiving a flow of liquid refrigerant from an inlet line and expelling the liquid refrigerant to an outlet line. A bypass line interconnects the inlet line and the outlet line and a bypass valve is configured to divert a portion or all of the flow of liquid refrigerant from the inlet line into the bypass line. A condition sensor provides a status signal indicative of refrigerant filter dryer condition and the bypass valve is operable responsive to the status signal.

### BACKGROUND INFORMATION

### Field

This disclosure relates generally to the field of vapor cycle machines and more particularly to a refrigerant filtration and drying functions (FDF) having a bypass loop and valve on a vapor cycle machine allows for continuous operation even during critical filter dryer end of life or failure conditions.

### Background

Aircraft, as well as other transportation and general heating ventilation and air conditioning (HVAC) systems, used in both commercial and private settings, employ vapor cycle machines. Modern commercial aircraft may feature a highly integrated air conditioning and pressurization system. Commonly, traditional air cycle based packs are utilized as a principal cooling plant for the airplane interiors. In some adaptations, this can be augmented by centralized or distributed smaller cooling units which are commonly a vapor cycle machine (VCM). In a VCM, work performed on a refrigerant enables air to ultimately be cooled in a heat exchanger (refrigerant evaporator). In some aircraft applications, the principal cooling plant can be entirely vapor cycle based. Given the transportation importance of environmental control, high reliability and availability of VCMs is needed to support transportation applications. For one example, in one aircraft application, an air cycle pack is augmented by a Supplemental Cooling System (SCS), a series of vapor cycle packs, that chill a coolant which is then circulated throughout the airplane. This coolant is used in food and beverage cooling for passenger service but also for cooling cabin and/or cargo recirculated air. The cooled recirculation air serves to cool the cabin and other areas of the airplane. As a result, the SCS function is highly important to airplane operations.

VCMs typically have component(s) providing a refrigerant filtration and drying function (FDF). These components normally have design life limitations and require maintenance repair or replacement as the unit accumulates operating hours or as the components become clogged. A failure in or wear out of FDF components may impact overall operation of the vapor cycle machine and in aircraft applications can also impact aircraft dispatch or operation. FDF components remove moisture and contaminants in refrigerant often generated by system wear or introduced in the system during manufacture or maintenance. Pressure loss increases and flow decreases typically with age and number of operating hours. Also, filter drier function life can decrease in severe conditions such as high cooling loads (hot air temperatures and high compressor speeds). If the filter wears (plugged or clogged), efficiency of the refrigeration system in typical designs, may be reduced or the system may need to be turned off. Loss of VCM air cooling capability on an aircraft may cause a flight to be delayed or cancelled.

### SUMMARY

Exemplary implementations of a filter dryer functions bypass system in a vapor cycle machine. The system includes a refrigerant filter/dryer receiving a flow of liquid refrigerant from an inlet line and expelling the liquid refrigerant to an outlet line. A bypass line interconnects the inlet line and the outlet line and a bypass valve is configured to divert a portion or all of the flow of liquid refrigerant from the inlet line into the bypass line. A condition sensor provides a condition status signal indicative of refrigerant filter dryer condition and the bypass valve is operable responsive to the condition status signal.

The implementations disclosed provide a method for operation of a vapor cycle machine. Condition of a refrigerant filter/dryer is sensed with a condition sensor. A condition status signal indicative of refrigerant filter/dryer condition is received from the condition sensor in a bypass controller. A bypass condition signal is issued from the bypass controller. A bypass valve is opened responsive to the bypass condition signal with the bypass valve configured to divert flow of liquid refrigerant from an inlet line inlet line of the refrigerant filter/dryer into a bypass line, the bypass line connected from the inlet line to an outlet line from the refrigerant filter/dryer.

### BRIEF DESCRIPTION OF THE DRAWINGS

The features, functions, and advantages that have been discussed can be achieved independently in various implementations or may be combined in yet other implementations further details of which can be seen with reference to the following description and drawings.

FIG. 1 is a representation of an exemplary vapor cycle machine with a FDF bypass system;

FIG. 2 is a detailed block diagram representation of a FDF bypass system for implementation in a vapor cycle machine as disclosed in FIG. 1;

FIG. 3 is a detailed block diagram view of a manual bypass valve for use in a FDF bypass system for implementation in a vapor cycle machine;

FIG. 4 is a flow chart of a method for operation of a vapor cycle machine with a FDF bypass system.

### DETAILED DESCRIPTION

The ability to sustain vapor cycle machine (VCM) operation with failed or degraded FDF components (beyond a normal maintenance cycle) is valuable. For aircraft, this can enable continued aircraft operation until maintenance can be performed at a more convenient time or place. For example, simple reconfiguration could allow aircraft operations for a time period, such as 10 days, until an effective repair or VCM replacement can occur. In transportation use, FDF components commonly require the VCM to be evacuated of refrigerant. This and equipment/tooling requirements typically require that VCM service occur in a shop environment. The implementations disclosed herein are demonstrated in aircraft applications; however, the concept is adaptable to other applications where cooling is critical, when extended/continuous operation of VCMs are required, and/or when space, weight, cost, or other constraints limit VCM or VCM component sizes. VCMs can be used but not limited to refrigeration, cooling, or heat pump applications. It is noted that bypass of the FDF function can result in further machine wear and may result in additional component failures affecting affecting repair costs. This is deemed an acceptable trade for increased availability as component wear is a prevalent cause of FDF wear out or failure. The implementation described herein provide a bypass system having a bypass loop and valve on a that allows for continuous operation even during critical filter dryer end of life or failure conditions. The implementations disclosed allow the vapor cycle machine to still operate, preventing shut down of supported systems, such as air conditioning (HVAC) systems used in commercial or private settings, aircraft food refrigeration or cabin cooling, preventing or minimizing airplane flight delays or cancellation of flights, and spoilage of food and/or beverages. This can yield maintenance efficiencies, operational efficiencies, cost savings, and customer satisfaction. While described herein for use with aircraft systems, the implementations can be used not only in the aerospace industry, but also in home and industrial applications (vapor cycle refrigeration systems). The bypass system described herein can operate manually or automatically with electromechanical valve and control components.

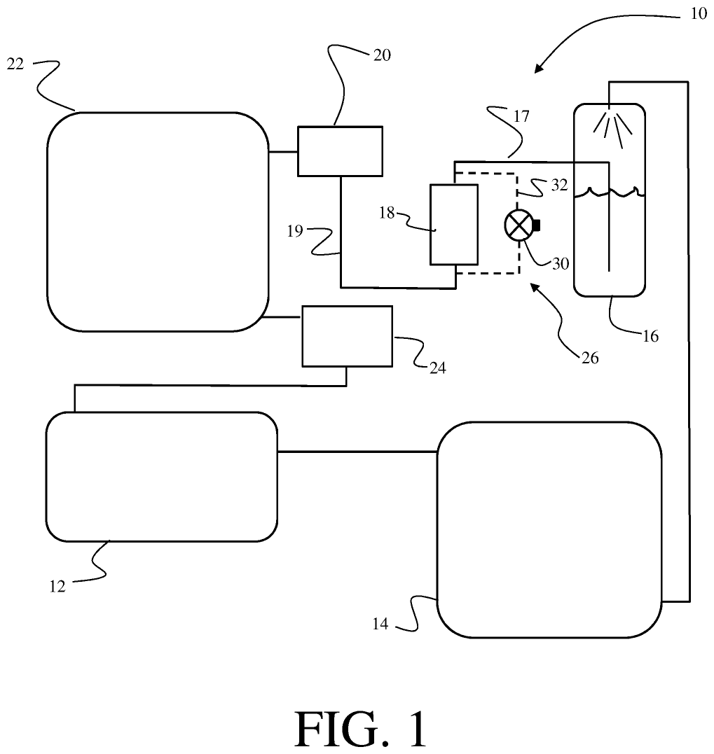

Referring to the drawings, FIG. 1 shows one typical example of a vapor cycle machine 10 for refrigeration having a compressor 12 feeding working fluid through a condenser 14 to a receiving tank 16 which stores the working fluid. Liquid refrigerant is withdrawn from the receiving tank 16 and routed with an inlet line 17 to a refrigerant filter/dryer 18. Liquid refrigerant flows from the refrigerant filter/dryer 18 to an outlet line 19 connected through an expansion valve 20 to an evaporator 22. A temperature sensing controller 24 controls flow of the working fluid through the evaporator to provide the desired refrigeration (evaporation) temperature (superheat control). The now gaseous working fluid is then returned to the compressor 12. A bypass system 26 allows rerouting of the working fluid flow partially or completely around the refrigerant filter/dryer 18. The refrigerant filter/dryer 18 is the FDF component addressed in the current implementation but the bypass system 26 may be applied to various other FDF components in similar vapor cycle machines.

In a first example implementation a bypass valve 30 is positioned in the bypass line 32 of bypass system 26 as shown in FIG.1. In this configuration, opening of the bypass valve 30 results in partial bypass of the flow of liquid refrigerant reducing the load on the refrigerant filter/dryer 18 but with continuing flow through the refrigerant filter/dryer unless the refrigerant filter dryer becomes fully plugged. In that condition, all flow is bypassed. Without bypass, a VCM commonly will be turned off due to excessive pressure when the FDF wears to the point of terminal pressure loss.

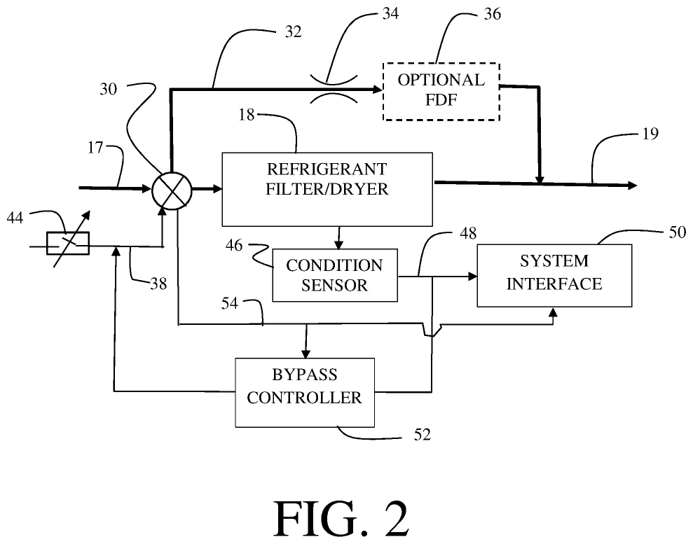

Details of a second example implementation of the bypass system 26 are seen in FIG. 2. A bypass valve 30 receiving flow from the inlet line 17 is configured to route liquid refrigerant into a bypass line 32, rejoining the outlet line 19 downstream of the refrigerant filter/dryer 18. As will be described in greater detail, the bypass valve 30 may route all or a portion of the flow of liquid refrigerant from the refrigerant filter/dryer 18 in response to a requirement for a bypass condition. An orifice 34 is optionally positioned in the bypass line 32 to limit flow in a manner consistent with normal flow through the refrigerant filter/dryer 18. Secondary FDF components 36, such as a reduced life or lower capacity filter/dryer, are optionally positioned in the bypass line 32 to maintain a filter/dryer function for liquid refrigerant flowing in the bypass condition. A combination of orifice 34 and FDF components 36 is matched in example implementations to provide comparable flow of liquid refrigerant in the bypass line to the normal flow condition through the refrigerant filter/dryer 18.

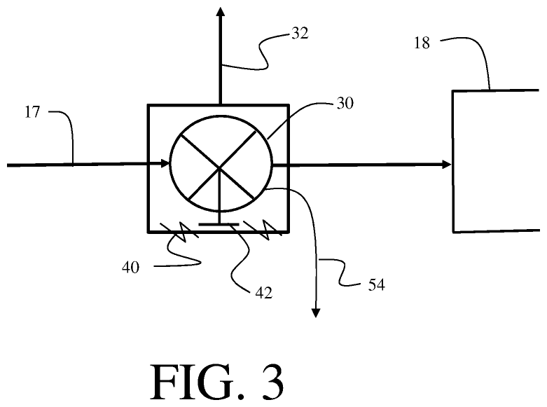

Bypass valve 30 may be a manual valve which is operated by a mechanic or technician based on a requirement for a bypass condition. Alternatively, bypass valve 30 may be an automatic electromechanical valve operated by a solenoid upon receipt of an electrical bypass condition signal 38. A hydraulically operated valve may also be employed for either manual or automatic operation. The bypass valve 30 may reroute all or a portion of the flow from the inlet line 17 using, for example, a three port ball valve or a positionable stem and multiseat valve. As seen in FIG. 3 for a mechanical valve implementation of bypass valve 30, a physical indicator to show the manual by-pass has been activated, such as a label or plastic rupturable retention feature 40 that is broken, cut, or torn for access to, or upon activation of, the manual valve operator 42 is provided in certain implementations. An electromechanical version of bypass valve 30 may be manually operated by a switch or switch rheostat 44, providing the bypass condition signal 38 as seen in FIG. 2, for full flow diversion or for controllable partial flow diversion.

In example implementations, as shown in FIG. 2, a condition sensor 46 is connected to the refrigerant filter/dryer 18 providing a condition status signal 48 indicative of refrigerant filter/dryer condition to a system interface 50. The condition status signal 48 and system interface 50 in certain manual implementations is a physical indicator for end of life of the refrigerant filter/dryer 18. In alternative implementations, the condition status signal 48 is derived from sensed states within the system (pressures, temperatures, compressor speeds, valve positions) or through other parameters such as number of operating hours since last service, output temperatures vs time, etc. A bypass controller 52, connected to receive the condition status signal 48, is operable to provide the bypass condition signal 38 responsive to the condition status signal 48 to operate bypass valve 30. At terminal life of the refrigerant filter/dryer 18 the bypass controller 52 issues a bypass condition signal for a fully open condition of bypass valve 30. In alternative implementations, the bypass controller 52 modulates the bypass condition signal 38 to operate the bypass valve 30 to gradually, incrementally, divert flow into the bypass line 32 as wear continues in the refrigerant filter/dryer 18. When the full open valve position is reached, bypass controller 52 could determine to fully shutdown the VCM or allow the unit to continue to operate until it fails or it is replaced. Shutdown of a VCM typically results in loss of VCM air cooling to the particular application (e.g. food chilling or cabin recirculation air cooling is lost). Bypass operation can retain VCM performance until repair or maintenance can occur. Performance is limited primarily by the wear state of the overall machine. Alternatively, the position of bypass valve 30 is modulated by the bypass controller 52 to continue flow and allow the refrigerant filter/dryer 18 to operate until it fails completely.

The system interface 50 connected to the condition sensor 46 and employing lights or other displayed digital warnings (e.g. Filter /drier is 50% life, at 100% life, has 2 days remaining of by-pass operation) to provide indication to a user, such as a pilot, mechanic or automated maintenance monitoring system, of the operating condition of the refrigerant filter/dryer 18 responsive to the condition status signal 48. A position status signal 54 from the bypass valve 30 is provided to the system interface 50 and is displayed to indicate operation or position of the valve. In certain implementations, the position status signal provides feedback to the bypass controller 52.

In certain implementations, dynamic life extension of the refrigerant filter/dryer 18 is obtained by automated operation of the bypass valve 30. When the vapor cycle machine 10 is operating at conditions where moisture or particulate risks are low (low power, stable refrigerant) the refrigerant filter/dryer 18 is by-passed automatically through operation of bypass valve 30. When conditions change, full refrigerant filter/dryer function can be restored by positioning the bypass valve 30 for no bypass flow. This may serve to extend the life of the filter function of the filter/drier. Bypass function is determined and controlled by the bypass controller 52 by sensing states within the system (pressures, temperatures, compressor speeds, valve positions or through other parameters like number of operating hours since last service, output temperatures vs time, etc.) provided by the condition sensor 46 or other operational sensors in the vapor cycle system or aircraft.

The disclosed implementations enable continued operation of the vapor cycle machine 10 for a limited time period until repair of the refrigerant filter/dryer 18 can be scheduled and accomplished (e.g. like 10 day MEL in the Aviation Industry). In a transport application, a vehicle could be used and then ferried to a maintenance station at a convenient time. Performance during the time limited period of bypass operation, depending on original refrigerant filter/drier sizing, would only be degraded slightly. Additionally, with automated control and modulation of the bypass valve 30, enhanced benefits such as increased refrigerant filter/dryer longevity may be obtained. Some level of filtration can also be maintained up to the point of full by-pass. Controlled bypass, particularly with added FDF components in the bypass line, can maintain the vapor cycle machine 10 at FDF terminal characteristics (pressure drop) to minimize further systems degradation and maximum level of FDF function.

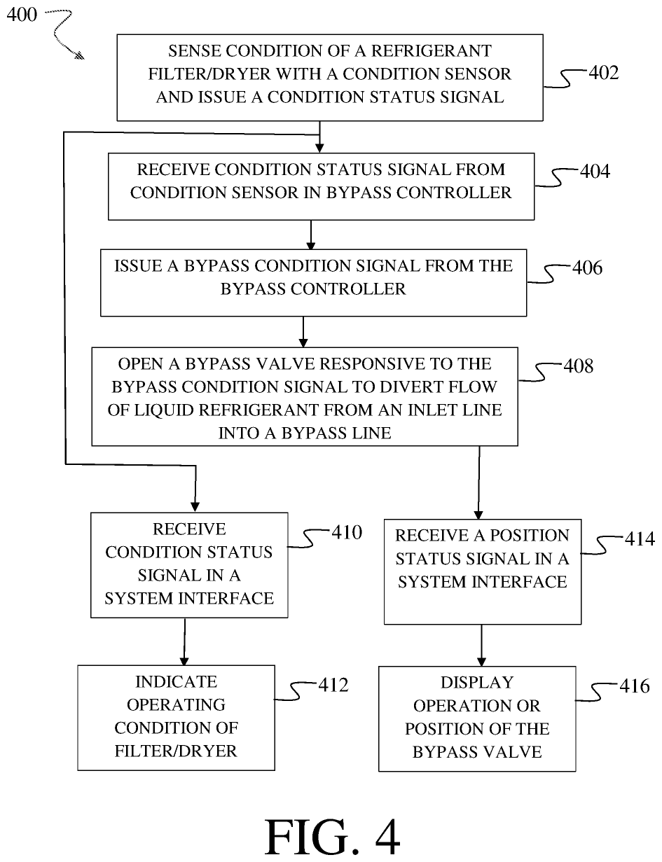

The implementations disclosed provide a method 400 for operation of a vapor cycle machine 10 as shown in FIG. 4. Condition of a refrigerant filter/dryer 18 is sensed with a condition sensor 46, step 402. A condition status signal 48 indicative of refrigerant filter/dryer condition is received from the condition sensor 46 in a bypass controller 52, step 404. A bypass condition signal 38 is issued from the bypass controller, step 406. A bypass valve 30 is opened responsive to the bypass condition signal with the bypass valve configured to divert flow of liquid refrigerant from an inlet line 17 into a bypass line 32, step 408, the bypass line connected from the inlet line 17 of the refrigerant filter/dryer to an outlet line 19 from the refrigerant filter/dryer. Opening of the bypass valve may be accomplished by modulating the bypass condition signal for full flow diversion or for controllable partial flow diversion by the bypass valve. The condition status signal is also received in a system interface 50, step 410. The system interface displays lights or other digital to provide indication to a user of the operating condition of the refrigerant filter/dryer 18, step 412. A position status signal 54 is received from the bypass valve 30 in the system interface 50, step 414. The system interface 50 then displays the position status signal to indicate operation or position of the bypass valve to the user, step 416.

Having now described various implementations of the invention in detail as required by the patent statutes, those skilled in the art will recognize modifications and substitutions to the specific implementations disclosed herein. Such modifications are within the scope and intent of the following claims. Within the claims the terms “comprising”, “including”, “having” and “containing” are intended to be open and additional or equivalent elements may be present. As used herein “and” and “or” are mutually inclusive unless otherwise limited.

What is claimed is:

1. A filter dryer functions bypass system in a vapor cycle machine, the system comprising:
a refrigerant filter/dryer receiving a flow of liquid refrigerant from an inlet line and discharging the liquid refrigerant to an outlet line;
a bypass line interconnecting the inlet line and the outlet line;
a bypass valve configured to divert a portion or all of the flow of liquid refrigerant from the inlet line into the bypass line; and
a condition sensor providing a condition status signal indicative of refrigerant filter dryer condition, said bypass valve operable responsive to the condition status signal.

2. The filter dryer functions bypass system in a vapor cycle machine as defined in claim 1 further comprising a flow limiting orifice in the bypass line.

3. The filter dryer functions bypass system in a vapor cycle machine as defined in claim 1 further comprising one or more secondary filter dryer function (FDF) components in the bypass line.

4. The filter dryer functions bypass system in a vapor cycle machine as defined in claim 3 wherein the one or more FDF components comprise a reduced life or lower capacity filter/dryer.

5. The filter dryer functions bypass system in a vapor cycle machine as defined in claim 1 further comprising a system interface.

6. The filter dryer functions bypass system in a vapor cycle machine as defined in claim 1, wherein said bypass valve is a manual valve.

7. The filter dryer functions bypass system in a vapor cycle machine as defined in claim 6 further comprising a rupturable retention feature 40 that is broken, cut, or torn for access to, or upon activation of, a manual valve operator on the manual valve.

8. The filter dryer functions bypass system in a vapor cycle machine as defined in claim 1 wherein said bypass valve is operated electromechanically responsive to a bypass condition signal.

9. The filter dryer functions bypass system in a vapor cycle machine as defined in claim 8 further comprising a switch or switch rheostat providing the bypass condition signal.

10. The filter dryer functions bypass system in a vapor cycle machine as defined in claim 8 further comprising a condition sensor connected to the refrigerant filter/dryer providing a condition status signal indicative of refrigerant filter/dryer condition.

11. The filter dryer functions bypass system in a vapor cycle machine as defined in claim 10 further comprising a bypass controller receiving the condition status signal, said bypass controller operable responsive to the condition status signal to provide the bypass condition signal to operate the bypass valve.

12. The filter dryer functions bypass system in a vapor cycle machine as defined in claim 11 wherein the bypass controller operates at terminal life of the refrigerant filter/dryer to provide a bypass condition signal to a fully open condition of the bypass valve.

13. The filter dryer functions bypass system in a vapor cycle machine as defined in claim 11 wherein the bypass controller modulates the bypass condition signal to operate the bypass valve to incrementally divert flow into the bypass line.

14. The filter dryer functions bypass system in a vapor cycle machine as defined in claim 1 further comprising a system interface having lights or other displayed digital warnings responsive to the condition status signal to provide indication to a user of the /condition.

15. The filter dryer functions bypass system in a vapor cycle machine as defined in claim 14 wherein the bypass valve provides a position status signal and the system interface provides an indication of bypass valve position responsive to the position status signal.

16. The filter dryer functions bypass system in a vapor cycle machine as defined in claim 11 wherein the bypass valve provides a position status signal as feedback to the bypass controller.

17. A method for operation of a vapor cycle machine, the method comprising:
sensing condition of a refrigerant filter/dryer with a condition sensor;
receiving a condition status signal indicative of refrigerant filter/dryer condition from the condition sensor in a bypass controller;
issuing a bypass condition signal from the bypass controller; and
opening a bypass valve responsive to the bypass condition signal, said bypass valve configured to divert flow of liquid refrigerant from an inlet line into a bypass line, said bypass line connected from an inlet line to the refrigerant filter/dryer to an outlet line from the refrigerant filter/dryer.

18. The method as defined in claim 17 wherein the step of opening a bypass valve comprises modulating the bypass condition signal for full flow diversion or for controllable partial flow diversion by the bypass valve.

19. The method as defined in claim 17 further comprising:
receiving the condition status signal in a system interface; and,
displaying lights or other digital to provide indication to a user of the refrigerant filter/dryer condition.

20. The method as defined in claim 19 further comprising receiving a position status signal from the bypass valve in the system interface; and
displaying the position status signal to indicate operation or position of the bypass valve.
